(19) United States
(12) Patent Application Publication
(10) Pub. No.: US 2026/0243279 A1
(43) Pub. Date: Aug. 20, 2026

(54) Systems and Methods for Improved Cycling of Valve Assemblies

(71) Applicant: Force Pressure Control, LLC, Seguin, TX (US)

(72) Inventors: Jacob Startz, Seguin, TX (US); Dustin Nesloney, Orange Grove, TX (US)

(73) Assignee: Force Pressure Control, LLC, Seguin, TX (US)

(21) Appl. No.: 19/055,101

(22) Filed: Feb. 17, 2025

(51) Int. Cl. F15B 15/14; E21B 43/26; F15B 1/04; F16K 31/122

(52) U.S. Cl. CPC F15B 15/1428; E21B 43/2607; F15B 1/04; F16K 31/122

(57) ABSTRACT

The present invention comprises a valve assembly with a hydraulic cylinder for controlling a component that is configured to open and close the valve. The hydraulic cylinder may comprise a first cavity and a second cavity wherein supplying a first cavity with fluid will force the component to open the valve, and supplying a second cavity with fluid will force the component to close the valve. In some embodiments, two hoses are connected to each cavity to supply fluid to the cavity and remove fluid from the cavity. A control system tracks and manages the volume of fluid supplied to the first and second cavities to open and close the valve efficiently. The additional hoses and control system improve cycle times of the valve assembly, while efficiently protecting the components of the valve assembly.

### TECHNICAL FIELD

The present invention relates generally to improving the cycle time of valve assemblies, and more specifically, an assembly for the hydraulic system of a valve that will decrease cycle times while protecting the components of the valve.

### BACKGROUND OF THE INVENTION

Valves are used in numerous industries to transport and control the flow of water or aqueous solutions, including the oil and gas industry. These valves are designed to start, stop, and even control the flow of liquids through the system. In the oil and gas industry, these liquids may include water, oil mixtures, frac fluids, or other liquid solutions that need to be transported to a well and into the ground or extracted from the ground. Grease, sand, or other foreign materials within the frac fluid may migrate from the valve passageway to the valve cavity or cavities to cause problems with the valve. At a multi-stage frac or oil & gas recovery site, there may be numerous wells with corresponding valves that are connected to deliver water or frac fluids in multiple stages. The valve assemblies are required to cycle between an open stage, where water for frac fluid is being delivered to the well, and a closed stage, where water or frac fluid is not being delivered to the well. A longer cycle time between open and closed stages means a longer stage, a longer transition, and risk of damage to the valve assembly during the cycle time as grease, sand, or other foreign materials may migrate from the flow bore of the valve to the cavities surrounding the valve. This cycle/transition period is crucial to operation of the frac or oil & gas recording site and the individual valve assemblies.

### BRIEF SUMMARY OF THE INVENTION

The present invention comprises a hydraulic assembly for a valve assembly that may improve cycle time and protect the components of the valve assembly. In some embodiments, more than two ports on a hydraulic cylinder may be used to efficiently cycle the valve assembly from open to closed or closed to open. Four ports may be used, wherein two ports are configured to supply fluid to a first cavity of a hydraulic cylinder to move a component (e.g., piston connected to a gate assembly) to open the valve, and two other ports are configured to supply fluid to a second cavity of the hydraulic cylinder to move a component to close the valve. Connectors may be used to connect multiple hoses to these ports for supplying the hydraulic fluid. In some embodiments, a control system or control unit may be used to measure, track, manage, and adjust the volume of liquid that is being supplied to the two cavities of the hydraulic cylinder. Sensors connected to or adjacent to the connectors may be used to transmit data related to volume of fluid being supplied to the hydraulic cylinder to the control system. By increasing the number of connections to supply hydraulic fluids to the hydraulic cylinder and improving control of the hydraulic fluid flowing into the hydraulic cylinder, cycle times can be reduced and components of the valve assembly may be better protected.

In some embodiments, the control system or control unit may adjust the volume being supplied to the cavities of the hydraulic cylinder during the opening or closing process to slow down the components before reaching fully open or fully closed. For example, hydraulic fluid may bypass the hydraulic cylinder as hydraulic piston nears fully open, or hydraulic fluid may be supplied to the opposite cavity as the hydraulic piston nears fully open to slow down the piston. The control system or control unit may comprise or be connected to an accumulator for supplying the hydraulic fluid. The control system or control unit may also be remotely controlled by an operator.

### BRIEF DESCRIPTION OF THE DRAWINGS

For a more complete understanding of the present invention, reference is now made to the following descriptions taken in conjunction with the accompanying drawing, in which:

FIG. 1 shows a front view of a traditional gate valve assembly;

FIG. 2 shows an exploded view of a traditional gate valve assembly;

FIG. 3 shows a front view of a gate valve assembly according to certain embodiments of the present invention;

FIGS. 4A and 4B shows a cross-section view and an internal view of a hydraulic cylinder assembly according to certain embodiments of the present invention;

FIG. 5 shows a front view of a gate valve assembly according to certain embodiments of the present invention;

FIGS. 6A and 6B show an internal view of a gate valve assembly according to certain embodiments of the present invention;

FIGS. 7A and 7B show an accumulator to be used in conjunction with the gate valve assembly according to certain embodiments of the present invention;

FIG. 8 shows a view of an accumulator to be used in conjunction with one or more gate valve assemblies according to certain embodiments of the present invention; and

FIG. 9 shows a multi-stage site with numerous wells, including gate valve assemblies according to certain embodiments of the present invention.

### DETAILED DESCRIPTION OF THE INVENTION

In general, valves or valve assemblies are used to control the movement of liquids, fluids, solutions, water, or other fluids at high pressures. Valves or valve assemblies may be used in various industries in numerous implementations, including but not limited to, the oil and gas industry. Within the oil and gas industry, there are numerous types of valves or valve assemblies that may use the present invention. The present invention is not limited to any specific valve or valve assembly and may be used in various industries and implementations. The figures and descriptions herein disclose a gate valve assembly as one embodiment, but the present invention is not limited to this embodiment. Gate valves or gate valve assemblies are commonly used at oil wells in fracturing (frac) operations. Fluids, such as frac fluids, may consist of water or other solutions combined with proppants or frac sand that pass through the gate valve assemblies. Pumps may be used to supply the valves with frac fluid or water. In frac operations, these gate valves may be required to start, adjust, and stop the flow of fluids at pressures of 15,000 psi and higher. In the field, these fluids with the proppants or frac sand may migrate from the valve passageways to cavities within the gate valve assemblies and may degrade the performance of the gate valve assembly. Grease or other materials have been injected to coat the interface surfaces to prevent fluids and proppants from entering the cavities of the valve assemblies, and commonly, the grease or other materials must be applied numerous times to ensure that the proppants or frac sand do not enter the passageways or cavities. In a multi-stage frac or oil & gas recovery site, cycle times may be crucial to efficiently frac each well and to transition between the stages of of the site. The cycle time may be referred to as the time that it takes a valve to transition from open to closed or between closed to open. When cycle times are high, it can (1) diminish oil & gas recovery from each well, (2) slow down transition time between wells, and (3) increase the risk of malfunction by increasing the time period that the valve is exposed in this transitional state. Cycle times may even be more crucial in continuous fracturing, where pumping is continuous through the transition through multiple wells.

When swapping wells at a multi-stage site, concerns may arise due to the varying fluid pressures on the valve assemblies. As the valve transitions from open to closed or closed to open, a void may be created inside the valve cavities, which can create a window or time period where the fluid may enter the cavities and cause significant damage to internal components of the valve assembly. A twelve-second cycle period provides a window where the components are moving, the pressures are changing, and fluid may escape the flow bore of the valve and migrate into cavities. This type of problem may lead to significant damage to internal components of the valve assembly, damage to the valve body, and evacuation of the grease that’s inside the cavity for protection of the components. Faster cycle times may lead to less risk of damage to internal components or the valve body.

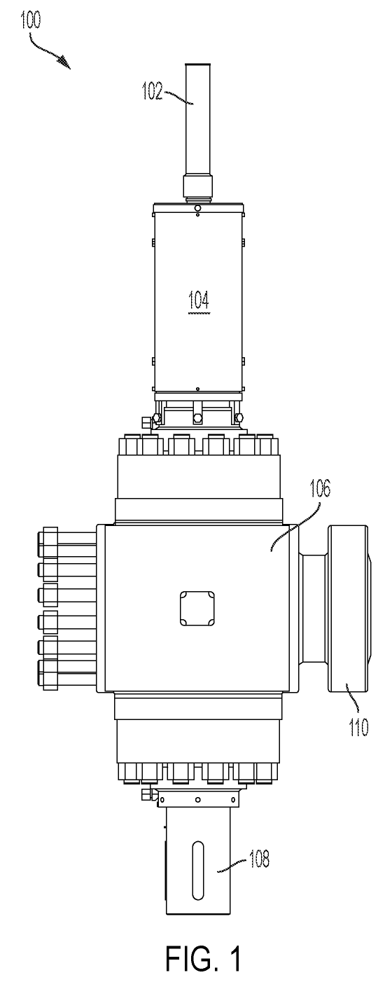

FIG. 1 shows a front view of a traditional gate valve assembly 100. While the figures shown herein relate to valve assemblies used in oil and gas operations, the present invention is not limited to valve assemblies in this industry and may cover valve assemblies used in other operations and industries. Indicator stem protector 102 is attached to a hydraulic cylinder 104 that remotely operates the valve assembly 100. Alternatively, a hand-wheel assembly could do the same. An operating stem (within 104) may be connected to a hand wheel (not shown) to manually open and close the gate valve assembly 100. A body 106 houses the functional portion of the valve and allows the fluid to pass through the gate valve assembly 100. A balance stem protector 108 protects a balance stem (not shown). A flange 110 may be used to connect other valves or pipes to the gate valve assembly 100. A gate (not shown) and a seat assembly (not shown) are located inside the body 106.

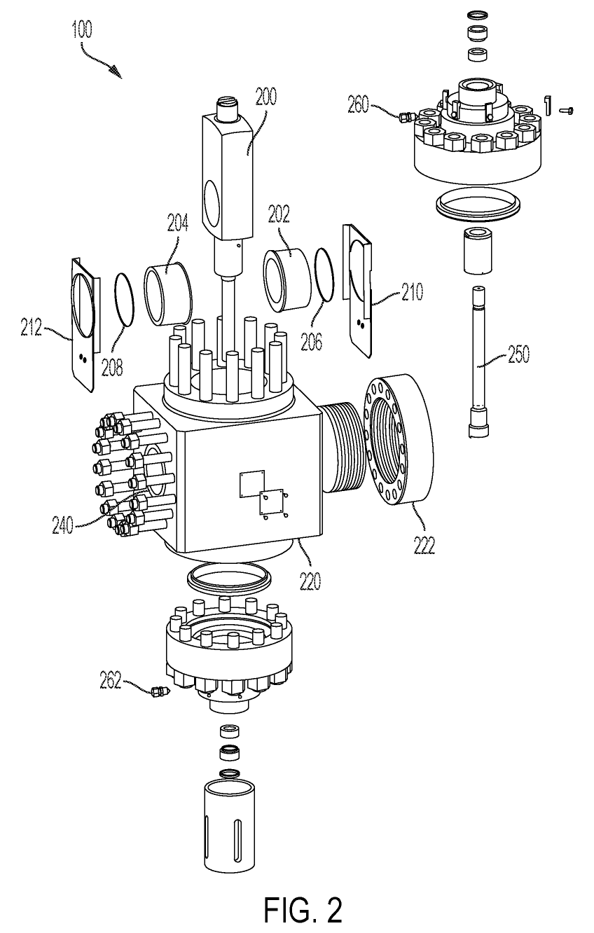

FIG. 2 shows an exploded view of the gate valve assembly 100 with the internal components. Once again, other types of valves are within the scope of the present invention, and the gate valve assembly 100 illustrates a single embodiment of the present invention. A gate 200 fits inside the gate valve assembly 100. An operating stem 250 enables the gate 200 to slide up and down within a body 220 of the gate valve assembly 100 to open and close the valve. Gate guides 210, 212 also protect the gate 200 during operation. The gate 200 connects to the operating stem 250 to enable remote control of the gate 200. For example, routing fluid remotely to hydraulic cylinder 104 will cause the operating stem 250 to push the gate 200 down or up to open or close the gate valve assembly 100. Two seats 202, 204 are located on each side of the gate 200. The gate 200 in conjunction with interface with the seats 202, 204 open and close the passageway within the body 220 of the gate valve assembly 100. Gate guides 210, 212 are also located on each side of the gate 200 to prevent material from entering or exiting the valve cavity as gate 200 opens and closes the valve. Seat seals 206, 208 may be used to seal the interfaces between the seats 202, 204 and seat pockets in valve body 220. In some embodiments, the fluid or water may enter the body 220 through passageway 240. In FIG. 2, the fluid may enter the gate valve assembly 100 through passageway 240 and exit the other side through a flange 222. Fluid into passageway 240 may be considered upstream, while fluid exiting flange 222 may be considered downstream. An upper port 260 and a lower port 262 may provide access to a cavity between the gate 200, the body 220, and the seat assemblies 202, 204. While the upper port 260 and lower port 262 may be used to apply grease to the cavity, it may also be used to obtain measurements within the cavity.

In addition to the gate valve assemblies shown in FIGS. 1 and 2, greaseless gate valve assemblies may be used in the oil and gas industry. Greaseless gate valve assemblies are designed to be used multiple times without disassembly or repair after each stage or use due to the ability of the gate valve assemblies to properly seal off the different cavities within and around the body of the gate valve assembly. For a greaseless valve, the improved sealing mechanism enables the cavities surrounding the flow bore of the valve to retain the grease and keeps the contaminants out of this cavity. Decreasing cycle times may be beneficial for traditional gate valve assemblies and greaseless gate valve assemblies.

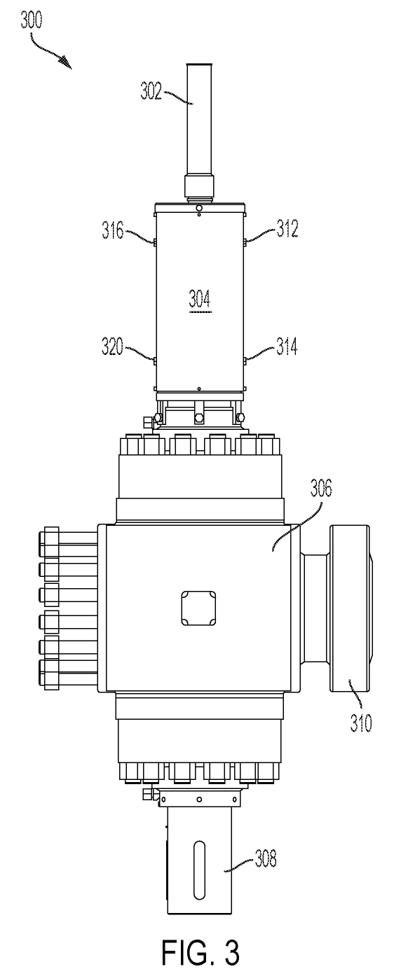

FIG. 3 shows a front view of a gate valve assembly 300 according to certain embodiments of the present invention. Indicator stem protector 302 is attached to a hydraulic cylinder 304 that remotely operates the gate valve assembly 300. A body 306 houses the functional portion of the valve and allows the fluid to pass through the gate valve assembly 300. A balance stem protector 308 protects a balance stem (not shown). A flange 310 may be used to connect other valves or pipes to the gate valve assembly 300. A gate (not shown) and a seat assembly (not shown) are located inside the body 306. The gate valve assembly 300 has two associated cavities, with one surrounding a gate assembly and the seat assemblies, and that other being the cavity (or passageway) where frac fluid flows through. The gate assembly, which is controlled by the operating stem (not shown) controls the fluid that runs through the passageway of the gate valve assembly 300.

In certain embodiments, a first port 312, second port 314, third port 316, and fourth port 320 are located on the hydraulic cylinder. These ports may be plugged, may be used for measurements, and may be connected to hoses to provide liquid to the hydraulic cylinder 304 for control of the operating stem. The ports 312, 314, 316, 320 may also be used for assembly and disassembly of the gate valve assembly 300. Many current gate valve assemblies 300 have these four ports. The two upper ports 312, 316 may be connected to hoses to deliver or remove liquid from hydraulic cylinder 304 and push a piston in one direction, and two lower ports 314, 320 may be connected to hoses to deliver or remove liquid from hydraulic cylinder 304 to push the piston in the opposition direction.

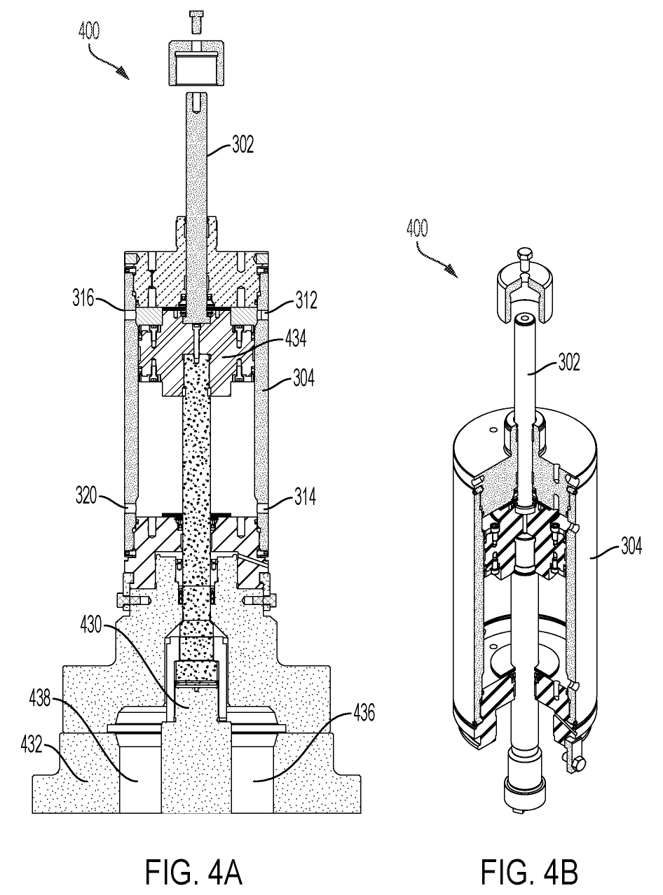

FIGS. 4A and 4B show a cross-section view and an internal view of a hydraulic cylinder assembly 400. The indicator stem 302 is attached to the hydraulic piston 434 that fits into hydraulic cylinder 304. The first port 312, second port 314, third port 316, and fourth port 320 may be used to deliver and remove liquid in the cavities of the hydraulic cylinder 304 to control the hydraulic piston 434. A body of the valve assembly 432 and a gate 430 are also shown in FIG. 4A. Two portions of a cavity 436, 438 surrounds the gate and seat assemblies. The hydraulic piston 434 is connected to the stem 302 to move up and down within the hydraulic cylinder 304 to open and close the gate 430. If liquid passes through one or more hoses into a cavity above the hydraulic piston 434 at ports 312, 316, then the liquid forces the hydraulic piston 434 down and pushes the gate 430 down. At this same time, liquid would be removed from a cavity below the hydraulic piston 434 at ports 314, 320. If liquid passes through one or more hoses into a cavity below the hydraulic piston 434 at ports 314, 320, then the liquid forces the hydraulic piston 434 up and pulls the gate 430 up. At this same time, liquid would be removed from a cavity above the hydraulic piston 434 at ports 312, 316. The hydraulic cylinder 304 controls the movement of the gate 430 through this hydraulic mechanism.

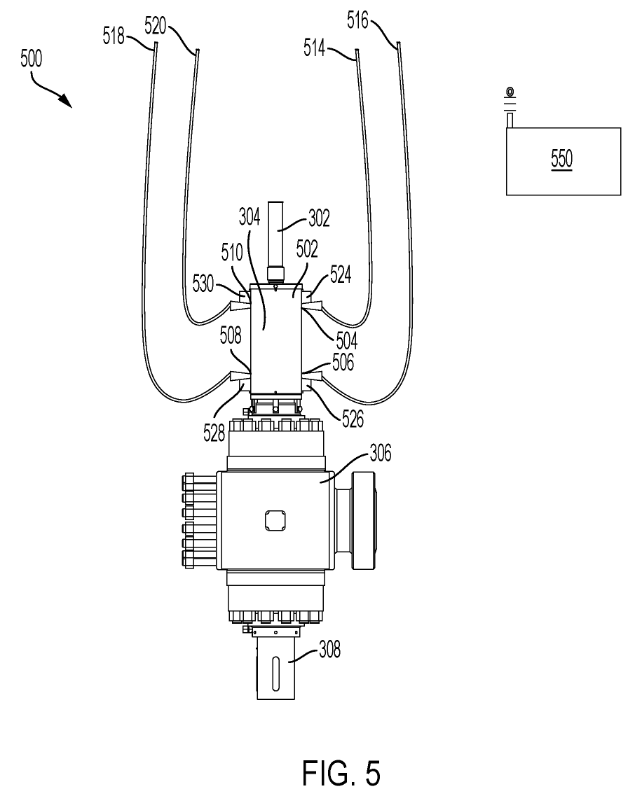

FIG. 5 shows a front view of a gate valve assembly 500 according to certain embodiments of the present invention. The gate valve assembly 500 is similar to gate valve assembly 300, but hoses are connected to the ports 312, 314, 316, 320 of FIG. 3. Indicator stem protector 302 is attached to a hydraulic cylinder 304 that remotely operates the gate valve assembly 500. A body 306 houses the functional portion of the valve and allows the fluid to pass through the gate valve assembly 300. A balance stem protector 308 protects a balance stem (not shown). A cavity 502 or two separate cavities within hydraulic cylinder 304 are used to control the hydraulic piston (not shown). A first connector 504 connects a hose 514 to the hydraulic cylinder 304 (through a port). A first sensor (or other measurement device) 524 may be used to control the first connector 504 and measure the fluid into and out of the cavity 502. A second connector 506 connects a hose 516 to the hydraulic cylinder 304 (through a port). A second sensor (or other measurement device) 526 may be used to control first connector 506 and measure the fluid into and out of the cavity 502. A third connector 510 connects a hose 520 to the hydraulic cylinder 304 (through a port). A third sensor (or other measurement device) 530 may be used to control third connector 510 and measure the fluid into and out of the cavity 502. A fourth connector 508 connects a hose 518 to the hydraulic cylinder 304 (through a port). A fourth sensor (or other measurement device) 528 may be used to control fourth connector 508 and measure the fluid into and out of the cavity 502. Additionally, sensors 524, 526, 528, 530 may include transceivers to be enabled to transmit to and receive data from a control unit 550. The control unit 550 may be remotely located from the gate valve assembly 500.

The ability to control the hydraulic cylinder 304 and the corresponding sensors 524, 526, 528, 530 through a control unit or system may take many different forms. For example, the data from the sensors may be uploaded to a website, where an operator can view and manage the valve assemblies through a website portal. The control system may also be offsite with electronic components for wireless reception and transmission onsite to communicate with the various components of the operation. In some embodiments, the control system may simply be a computer or tablet with corresponding software to run the fracturing operation onsite. By moving control of the system to a computer, tablet, website, or remote locations with corresponding computer software, safety may be improved because workers can stay a safe distance away from the operation. Computer software may be used to analyze the sensor readings and present the information to the operator.

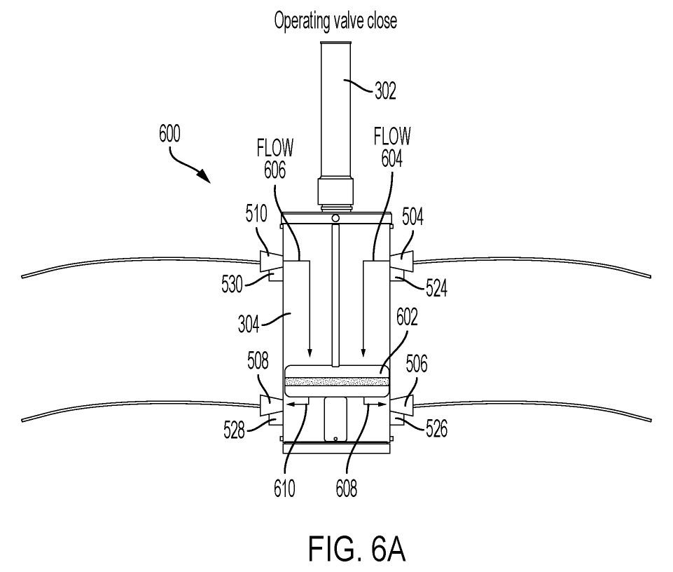

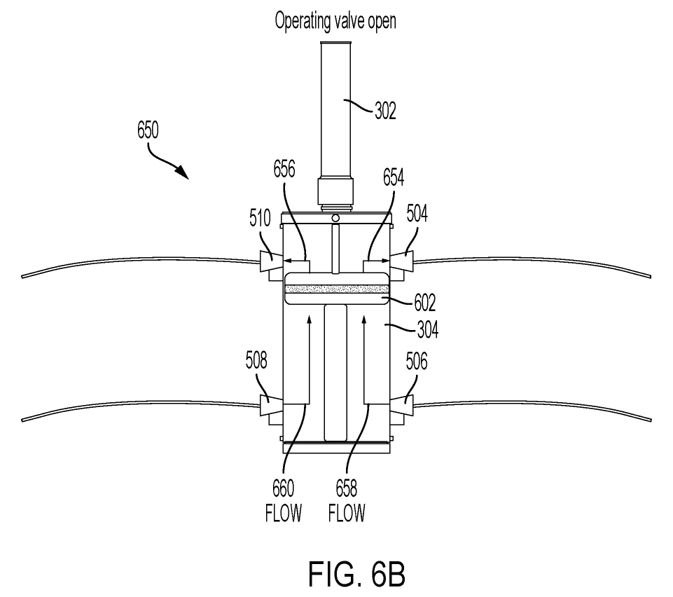

FIGS. 6A and 6B show an internal view of a gate valve assembly 600, 650 according to certain embodiments of the present invention. FIGS. 6A and 6B show the internal operation of the gate valve assembly 500 from FIG. 5. A hydraulic piston 602 may be configured to control the gate (not shown) of the valve assembly with a cavity above and a cavity below the piston 602. Connectors 504, 506, 508, 510 enable hoses to deliver fluid to and remove fluid from the cavities above and below the piston 602. As fluid enters the hydraulic cylinder 304 through connectors 504, 510 the cavity above the piston 602 fills up with fluid. As shown in FIG. 6A, flows 604 and 606 represent fluid entering the cavity and pushing the piston 602 to the lower portion of the hydraulic cylinder 304. Fluid would be removed from the cavity below the piston 602 during this time, which is shown by flows 608 and 610. As shown in FIG. 6B, flows 658 and 660 represent fluid entering the cavity and pushing the piston 602 to the upper portion of the hydraulic cylinder 304. Fluid would be removed from the cavity above the piston 602 during this time, which is shown by flows 654, 656. By using all four ports on the hydraulic cylinder 304, the piston 602 may move faster to open and close the gate of the valve assembly 600, 650.

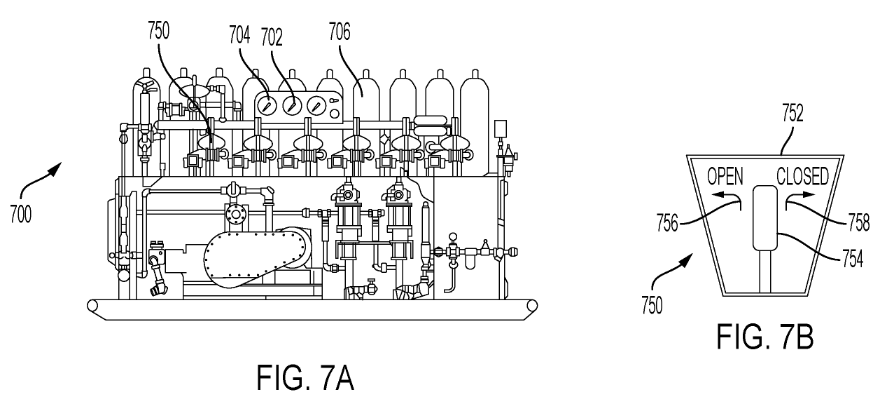

FIGS. 7A and 7B show an accumulator 700 to be used in conjunction with the gate valve assembly according to certain embodiments of the present invention. This may be the front side of the accumulator 700. According to certain embodiments of the present invention, the accumulator 700 may control the hydraulic fluid being applied to the hydraulic cylinder (not shown) of the gate valve assembly. At least one manifold gauge 702 and at least one accumulator pressure gauge 704 track and display the pressures at the manifold and the accumulator 700. One or more gas tanks 706 may allow the accumulator 700 to apply the proper pressure to circulate the hydraulic fluid. One or more open and closed levers 750 may control the hydraulic fluid that is being applied to the hydraulic cylinder. FIG. 7B shows the open and closed lever 750 through a display 752, where an indicator 754 displays whether the hydraulic fluid is being used to open 756 the valve assembly or close 758 the valve assembly. The open and closed lever 750 may be manually controlled or remotely controlled by control logic or computer software.

In certain embodiments, the accumulator pressure may be set to 3000 PSI, which powers or starts the accumulator 700 when the pressure reaches 1000 PSI. The manifold pressure may be set to the amount of pressure that you want the accumulator to push the hydraulic fluid through the hoses to operate the valve for each lever. To open an accumulator valve, you may pull the lever/indicator 754 to the open position 756, which forces hydraulic fluid to be pushed through the hoses that are connected to the accumulator to activate movement of the hydraulic piston and open the gate valve assembly. To close the accumulator valve, you may pull the lever/indicator 754 to the closed position 758, which forces hydraulic fluid to be pushed through the hose to activate the opposite movement of the hydraulic piston to close the gate valve assembly. In various embodiments, the delivery of the hydraulic fluid may be controlled by a control system or control unit that manages and controls the accumulator 700, the connectors to the hydraulic cylinder, or both.

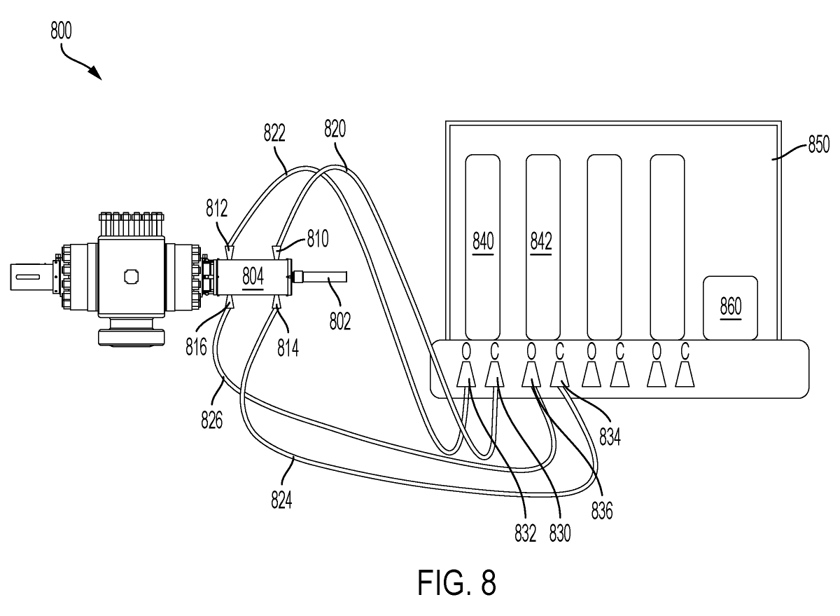

FIG. 8 shows a view of an accumulator 850 to be used in conjunction with one or more gate valve assemblies 800. This may be the backside view of the accumulator 700. The gate valve assembly has an indicator stem 802 and a hydraulic cylinder 804. First connector 810 connects a first hose 820 to the hydraulic cylinder 804. The first hose 820 is connected to a first closed fitting 830 of an accumulator display 850. A second connector 812 connects a second hose 822 to the hydraulic cylinder 804. The second hose 822 is connected to a first open fitting 832 of the accumulator display 850. A third connector 814 connects a third hose 824 to the hydraulic cylinder 804. The third hose 824 is connected to a second closed fitting 834 of the accumulator display 850. A fourth connector 816 connects a fourth hose 826 to the hydraulic cylinder 804. The fourth hose 826 is connected to a second open fitting 836 of the accumulator display 850. First hydraulic fluid display 840 shows the hydraulic fluid available to the first hose 820 and second hose 822, and second hydraulic fluid display 842 shows the hydraulic fluid available to the third hose 824 and fourth hose 826. In some embodiments, the first open fitting 832 and second open fitting 836 operate in conjunction to supply hydraulic fluid to hydraulic cylinder 804 to open the gate valve assembly. The first closed fitting 830 and second closed fitting 834 operate in conjunction to supply hydraulic fluid to hydraulic cylinder 804 to close the gate valve assembly. The hydraulic fluid displays 840, 842 may adjust based upon the hydraulic fluid being supplied to the gate valve assembly. In some embodiments, control unit 860 (or processor) may track and manage the hydraulic fluid that is being supplied and removed from hydraulic cylinder 804. The connectors 810, 812, 814, 816 may have valves to independently start or stop the flow of hydraulic fluid into the hydraulic cylinder.

In standard accumulator configurations, each open/closed fitting supplies hydraulic fluid to a single gate valve assembly. Thus, only two ports are used to open and close the gate valve assembly. This causes the hydraulic piston to transfer from an open position to a closed position slower than it would through the use of four ports to open and close the gate valve. With some embodiments, the cycle time from open to close or close to open is 12 seconds with only two ports in use, and the cycle time may be reduced to 2 second with four ports in use. Not only can cycle times be reduced, but the additional ports may give the operator more control and flexibility with opening and closing the valve. One concern is that if the cycle times are reduced drastically, the components of the valve assembly may be adversely affected or damaged. Adjusting the flow of hydraulic fluid to the hydraulic cylinder may alleviate this concern by slowing the process as the valve assembly gets closer to 100% open or closed.

For example, using the two (of four) hoses to open the valve may reduce the cycle time to 2 seconds because of the additional hydraulic fluid being supplied to the hydraulic cylinder. But this may force the hydraulic piston and components of the gates to contact the other components of the valve assembly with larger momentum. As the hydraulic piston gets 80% or 90% to fully open or fully closed, additional fluid may be supplied to the opposite cavity to slow down the speed at which the hydraulic piston is opening or closing. Or as the hydraulic piston gets 80% or 90% to fully open or fully closed, the supply of hydraulic fluid may be reduced or cut off to reduce the speed at which the hydraulic piston is opening or closing. The sensors in conjunction with the control unit may be used to track the progress of the hydraulic piston and/or the volume of the hydraulic fluid to make these types of adjustments. For example, sensors may track the location of the piston within the hydraulic cylinder or may better control the rate at which the hydraulic fluid is being supplied to the cavities of the hydraulic cylinder. In some embodiments, the connectors 810, 812, 814, 816 and/or the accumulator 850 may be controlled to stop the flow of hydraulic fluid (close an internal valve or bypass the hydraulic cylinder) when the hydraulic piston gets close to fully open or fully closed in order slow the process. While this embodiment may slow the cycle time, it may reduce the wear and tear on the components of the valve assembly.

In one embodiment, an additional fluid tank may be used in conjunction with the gate valve assembly to house or store hydraulic fluid that will enter the hydraulic cylinder. The additional fluid tank could be located at the accumulator or closer to the gate valve assembly. The volume of fluid supplied to the hydraulic cylinder may be measured or tracked to predict when the hydraulic cylinder is 80% or 90% of full capacity (fully open or fully closed). At this threshold, the hydraulic fluid may bypass the hydraulic cylinder and flow into the tank to slow down the gate assembly as it approaches fully open or fully closed. After said threshold is reached, a check valve may be used to divert or bypass the incoming fluid to the tank, or a pressure valve may be used to lower the pressure as the gate assembly approaches fully open or fully closed. For example, 900 psi may be applied to the fluid from the accumulator to the hydraulic cylinder until the threshold is met, and then 300 psi is applied to the fluid to slow the progress of the gate valve assembly. The tank may also be used to better track or measure the hydraulic fluid as it is supplied to the hydraulic cylinder. These embodiments may assist with creating a soft landing for the piston and/or the gate assembly.

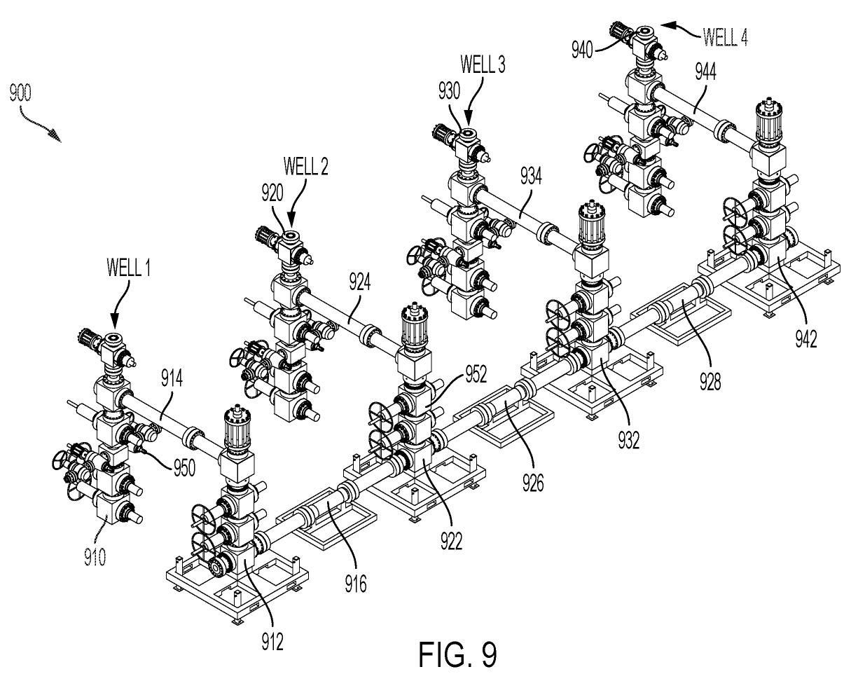

FIG. 9 shows a four-well fracturing system 900 according to certain embodiments of the present invention. A frac manifold is made up of four separate portions with one for each well 912, 922, 932, 942. First portion 912 is connected to a first frac tree 910 through a first fluid connector 914. Second portion 922 is connected to a second frac tree 920 through a second fluid connector 924. Third portion 932 is connected to a third frac tree 930 through a third fluid connector 934, and fourth portion 942 is connected to a fourth frac tree 940 through a fourth fluid connector 944. The fluid connectors 914, 924, 934, 944 supply frac fluids from the portions of the frac manifold 912, 922, 932, 942 to the frac trees 910, 920, 930, 940. Further, the portions of the frac manifold are fluidly connected through fluid connections 916, 926, 928. With these fluid connections 916, 926, 928, the system 900 may transport water from Well 1 to Well 4 or from Well 4 to Well 1. Thus, the fluid supply (not shown) can be connected to different portions of the frac manifold 912, 922, 932, 942, but supply frac fluids to all of the frac trees 910, 920, 930, 940 and corresponding Wells (1, 2, 3, 4).

At least one equalizing valve 950 may be used on each frac tree and at least one hydraulic valve 952 may be used on each frac manifold. The valves control the directions and pressures of the frac fluids in the frac system 900. Specifically, valves located at the portions of the frac manifold 912, 922, 932, 942 and frac trees 910, 920, 930, 940 may be used in conjunction to deliver the frac fluids to any of the Wells (1, 2, 3, 4), thereby enabling one fracturing system 900 to operate through four separate wells. Due to the vast volumes of frac fluids and the high pressures involved with fracturing a well, the valves must be reliable and must be operated with precision. The present invention may be used with multiple valves for the same well, multiple valves over multiple wells, or just a single valve. The configuration of the accumulator and the hydraulic hoses can be adjusted for these applications. As discussed above, sensors may be used in these embodiments to track and manage the hydraulic fluid being supplied and removed from the hydraulic cylinders of the valves.

The ability to control the hydraulic cylinder of multiple valves and the corresponding sensors through a control unit or system may take many different forms. By seamlessly and efficiently controlling the operation of multiple valves across multiple wells, continuous operation may be achieved. A first well may be swapped for a second well more efficiently with reduced cycle times for opening and closing the valves. For example, the data from sensors and the accumulator may be uploaded to a website, where an operator can view and manage the valve assemblies through a website portal. The control system may also be offsite with electronic components for wireless reception and transmission onsite to communicate with the various components of the operation. In some embodiments, the control system may simply be a computer or tablet with corresponding software to run the fracturing operation onsite. Computer software may be used to analyze the sensor readings and present the information to the operator.

This disclosure includes additional types of valves using hydraulic cylinders that may benefit from faster cycle times. For example, Globe Valves may benefit from more efficient application of hydraulic fluid to open and close the valves. Ball Valves may also benefit from the present invention through improved transmission of hydraulic fluids.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A valve assembly comprising:
a valve;
a hydraulic cylinder that is configured to control the valve with a component that is configured to open and close the valve, wherein the hydraulic cylinder further comprises two cavities;
a first connector connected to a first hose and a second connector connected to a second hose, wherein the first hose and the second hose are configured to fill a first cavity of the hydraulic cylinder with fluid;
a third connector connected to third hose and a fourth connector connected to a fourth hose, wherein the third hose and the fourth hose are configured to fill a second cavity of the hydraulic cylinder with fluid; and
a control system that is configured to control a supply of fluid to the first hose and the second hose to move the component to open the valve, and is configured to control the supply of fluid to the third hose and the fourth hose to move the component to close the valve.

2. The valve assembly of claim 1 wherein the valve assembly is a gate valve assembly and the component is a gate assembly.

3. The valve assembly of claim 1 further comprising an accumulator that is configured to supply fluid to the first hose, the second hose, the third hose, and the fourth hose.

4. The valve assembly of claim 3 wherein the control system is further configured to control the fluid that is being supplied by the accumulator to the first hose, the second hose, the third hose, and the fourth hose.

5. The valve assembly of claim 1 further comprising at least one first sensor that is adjacent to the first connector, at least one second sensor that is adjacent to the second connector, at least one third sensor that is adjacent to the third connector, and at least one fourth sensor that is adjacent to the fourth connector, wherein the first sensor, the second sensor, the third sensor, and the fourth sensor are configured to measure a volume of fluid that enters the hydraulic cylinder.

6. The valve assembly of claim 5 wherein the control system is further configured to manage the volume of fluid that enters the hydraulic cylinder through the first hose, the second hose, the third hose, and the fourth hose.

7. The valve assembly of claim 1 wherein the control system is further configured to adjust the supply of fluid to the hydraulic cylinder by the first hose, the second hose, the third hose, and the fourth hose by controlling the first connector, the second connector, the third connector, and the fourth connector.

8. The valve assembly of claim 7 wherein the control system is further configured to adjust the supply of fluid to the hydraulic cylinder at the same time that the component is moving to open the valve and at the same time that the component is moving to close the valve.

9. A valve assembly comprising:
a valve;
a hydraulic cylinder with at least two cavities, wherein a piston within the hydraulic cylinder is connected to a component that is configured to open and close the valve;
a first connector connected to a first hose and a second connector connected to a second hose, wherein the first hose and the second hose are configured to fill a first cavity of the hydraulic cylinder with fluid;
a third connector connected to third hose and a fourth connector connected to a fourth hose, wherein the third hose and the fourth hose are configured to fill a second cavity of the hydraulic cylinder with fluid; and
an accumulator that is configured to control a supply of fluid to the first hose and the second hose to move the piston to open the valve, and is configured to control the supply of fluid to the third hose and the fourth hose to move the piston to close the valve.

10. The valve assembly of claim 9 wherein said accumulator may be remotely controlled by an operator.

11. The valve assembly of claim 9 further comprising a control unit for controlling a volume of fluid to be supplied to the hydraulic cylinder through the first hose, the second hose, the third hose, and the fourth hose.

12. The valve assembly of claim 11 wherein the control unit is further configured to measure the volume of fluid to be supplied to the hydraulic cylinder through the first hose, the second hose, the third hose, and the fourth hose and adjust the volume of fluid to be supplied to the hydraulic cylinder through the first hose, the second hose, the third hose, and the fourth hose.

13. The valve assembly of claim 12 wherein the control unit is further configured to control the first connector, second connector, third connector, and fourth connector.

14. The valve assembly of claim 11 further comprising a first sensor to measure the volume of fluid supplied to the hydraulic cylinder by the first hose, a second sensor to measure the volume of fluid supplied to the hydraulic cylinder by the second hose, a third sensor to measure the volume of fluid supplied to the hydraulic cylinder by the third hose, and a fourth sensor to measure the volume of fluid supplied to the hydraulic cylinder by the fourth hose.

15. A valve assembly for use in frac operations to deliver fluid to a well site comprising:
a valve;
a hydraulic cylinder that is configured to control the valve with a component that is configured to open and close the valve;
a first connector that is configured to be connected to a first hose and a second connector that is configured to be connected to a second hose, wherein the first connector and the second connector are configured to fill a first cavity of the hydraulic cylinder with fluid;
a third connector that is configured to be connected to third hose and a fourth connector that is configured to be connected to a fourth hose, wherein the third connector and the fourth connector are configured to fill a second cavity of the hydraulic cylinder with fluid; and
at least one first sensor that is configured to measure a first volume of fluid, at least one second sensor that is configured to measure a second volume of fluid, at least one third sensor that is configured to measure a third volume of fluid, and at least a fourth sensor that is configured to measure a fourth volume of fluid;
wherein the first connector, the second connector, the third connector, and the fourth connector are configured to be controlled by a control system.

16. The valve assembly of claim 15 wherein the component is a piston.

17. The valve assembly of claim 15 wherein the first connector, the second connector, the third connector, and the fourth connector are further configured to enable fluid to enter the hydraulic cylinder and configured to enable fluid to exit the hydraulic cylinder.

18. The valve assembly of claim 15 wherein the first sensor, the second sensor, the third sensor, and the fourth sensor are configured to transmit data to the control system.

19. The valve assembly of claim 15 wherein the control system further comprises an accumulator.

20. The valve assembly of claim 19 wherein the control system is further configured to adjust the volume of fluid supplied to the hydraulic cylinder while the valve is opening or closing.
